(19) United States
(12) Patent Application Publication
(10) Pub. No.: US 2026/0122128 A1
(43) Pub. Date: Apr. 30, 2026

(54) NETWORK LAYER DC POWER SAVINGS SYNCHRONIZATION SOLUTION FOR AN INTERNET ARCHITECTURE

(71) Applicant: QUALCOMM Incorporated, San Diego, CA (US)

(72) Inventors: Arnaud MEYLAN, San Diego, CA (US); Lenaig Genevieve CHAPONNIERE, La Jolla, CA (US)

(21) Appl. No.: 18/927,649

(22) Filed: Oct. 25, 2024

(51) Int. Cl. H04L 67/1095; H04W 52/02

(52) U.S. Cl. CPC H04L 67/1095; H04W 52/0216

(57) ABSTRACT

Aspects of the disclosure are directed to network layer power savings synchronization. In accordance with one aspect, the disclosure includes updating a sleep/power pattern using a plurality of modified pattern elements to generate an updated sleep/power pattern; sending the updated sleep/power pattern to a plurality of client nodes for a network layer synchronization of a plurality of client tasks, wherein the network layer synchronization of the plurality of client tasks is based on the plurality of modified pattern elements; and executing a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks.

### TECHNICAL FIELD

This disclosure relates generally to the field of dc power savings in an Internet architecture, and, in particular, to network layer power savings synchronization.

### BACKGROUND

An Internet architecture is an evolving networking construct where spatially distributed and heterogeneous nodes (e.g., devices, machines and platforms) and network infrastructure are interconnected over a wide area network (WAN) to facilitate synergistic applications. The nodes may be locally interconnected using either wireless or wired transmission paths to a network hub (e.g., aggregator). The network hub may then be remotely interconnected to network infrastructure such as gateways, routers, switches etc. to permit access to the Internet (i.e., a global internetworking facility). Since the nodes typically operate asynchronously (i.e., without time coordination), the network hub may operate with a high duty cycle which may result in excessive dc power demand. Thus, an alternative Internet architecture is desired for improved dc power efficiency.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides network layer power savings synchronization. Accordingly, the present disclosure discloses an apparatus including: a first client node configured to execute a first plurality of Internet applications; a second client node configured to execute a second plurality of Internet applications; and a switching node coupled to the first client node and the second client node, the switching node configured to allow execution of the first plurality of Internet applications and the second plurality of Internet applications synchronously using a network layer synchronization.

In one example, the apparatus further includes a network infrastructure coupled to the switching node, the network infrastructure configured to host the first plurality of Internet applications and the second plurality of Internet applications. In one example, the apparatus further includes a first client access link coupled to the first client node, the first client access link configured to connect the first client node to the switching node; and a second client access link coupled to the second client node, the second client access link configured to connect the second client node to the switching node.

In one example, the apparatus further includes a common time reference coupled to the first client node, the common time reference configured to provide a common notion of time for the first client access link and the second client access link, wherein the first client access link and the second client access link are incompatible and asynchronous. In one example, the common time reference is obtained through one of the following: a usage of a network time protocol (NTP), a usage of a precision time protocol (PTP) or derived from Global Positioning System (GPS) time through a Global Positioning System (GPS) receiver.

In one example, the first client node is further configured to generate a sleep/power pattern to include a plurality of pattern elements for the second client node. In one example, the second client node votes to endorse or reject the sleep/power pattern by a binary indication of approval or disapproval.

Another aspect of the disclosure provides an apparatus including: means for updating a sleep/power pattern using a plurality of modified pattern elements to generate an updated sleep/power pattern; means for sending the updated sleep/power pattern to a plurality of client nodes for a network layer synchronization of a plurality of client tasks, wherein the network layer synchronization of the plurality of client tasks is based on the plurality of modified pattern elements; and means for executing a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks.

In one example, the apparatus further includes means for modifying a plurality of pattern elements based on a feedback to generate the plurality of modified pattern elements. In one example, the apparatus further includes means for generating the sleep/power pattern to include the plurality of pattern elements for the plurality of client nodes.

Another aspect of the disclosure provides a method including: updating a sleep/power pattern using a plurality of modified pattern elements to generate an updated sleep/power pattern; sending the updated sleep/power pattern to a plurality of client nodes for a network layer synchronization of a plurality of client tasks, wherein the network layer synchronization of the plurality of client tasks is based on the plurality of modified pattern elements; and executing a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks.

In one example, the method further includes modifying a plurality of pattern elements based on a feedback to generate the plurality of modified pattern elements. In one example, the method further includes generating the sleep/power pattern to include the plurality of pattern elements for the plurality of client nodes. In one example, each of the plurality of client nodes votes to endorse or reject the sleep/power pattern by a binary indication of approval or disapproval.

In one example, the method further includes establishing a network layer synchronization among the plurality of client nodes using the updated sleep/power pattern. In one example, the network layer synchronization among the plurality of client nodes provides a common notion of time for incompatible and asynchronous client access links. In one example, the network layer synchronization of the plurality of client tasks provides a common time reference for each of the plurality of client tasks such that the each of the plurality of client tasks executes synchronously with the others of the plurality of client tasks.

In one example, the plurality of modified pattern elements includes a modified awake time periodicity. In one example, the execution of the plurality of latency-tolerant client tasks is delayed according to the modified awake time periodicity and a modified ON duration using the common time reference. In one example, the common time reference is obtained through one of the following: a usage of a network time protocol (NTP), a usage of a precision time protocol (PTP) or derived from Global Positioning System (GPS) time through a Global Positioning System (GPS) receiver.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example wide area network (WAN) interconnection scenario.

FIG. 2 illustrates an example physical layer doze mode timeline.

FIG. 3 illustrates an example layered structure for an Internet architectural framework.

FIG. 4 illustrates an example flow diagram for an Internet architecture network layer dc power savings synchronization solution.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An Internet architecture may be used for a plurality of client nodes with heterogeneous devices and diverse applications. The plurality of client nodes may obtain Internet access through a local area network (LAN). For example, the LAN may be based on either a wired LAN protocol (e.g., Ethernet) or a wireless LAN protocol (e.g., WiFi). In one example, the LAN is connected to a wide area network (WAN), either wired or wireless, for global Internet connectivity using the Internet protocol (IP) with a network hub. In one example, the network hub may be an aggregator, a network switch, an IP router, a gateway, etc. and the network hub may be connected to a WAN backhaul transport network. For example, the WAN backhaul transport network may be connected to a radio access network (RAN) for wireless access (e.g., a next generation node B, gNB).

In one example, the network hub may be a mobile hotspot, an Internet protocol (IP) router, customer premises equipment (CPE) with a home WiFi/Ethernet router, a mobile broadband (MBB) router, etc. In one example, the network hub (e.g., IP router) does not control user traffic from the plurality of client nodes, but only provides a transport service for the plurality of client nodes. In one example, the plurality of client nodes may connect to the network hub using various access protocols such as WiFi, Ethernet, Sidelink, Universal Serial Bus (USB), Peripheral Component Interconnect express (PCIe), network on a chip (NOC), etc.

In one example, the plurality of client nodes operates asynchronously; that is, with no common time reference. For example, a lack of a common time reference implies that each client node has a separate notion of time. For example, having a separate notion of time means having no common agreement of a time scale. Thus, asynchronicity results from a lack of a common agreement of a time scale.

In one example, the plurality of client nodes operates with various operating systems (OS). For example, each operating system for each client node does not operate synchronously with another operating system for another client nodes. As a consequence, the network hub may operate with a high duty cycle (i.e., long activation times) even with low duty cycle client nodes. That is, the network hub remains in an active connection state for a high time fraction due to timing overhead in transitioning between an active connection state and a standby state.

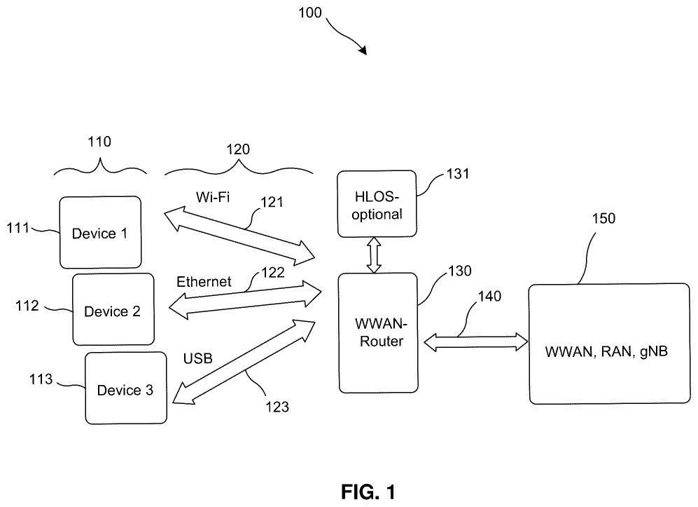

FIG. 1 illustrates an example wide area network (WAN) interconnection scenario 100. In one example, a plurality of client nodes 110 includes a first client node (e.g., a first device) 111, a second client node (e.g., a second device) 112, a third client node (e.g., a third device) 113, etc. In one example, the plurality of client nodes 110 obtain LAN access using a plurality of LAN access paths 120 such as WiFi 121, Ethernet 122, USB 123, etc. In one example, the plurality of LAN access paths 120 access a network hub 130. In one example, the network hub is an IP router or a wireless WAN (WWAN) router. In one example, the network hub may be operated with a high-level operating system (HLOS).

In one example, the network hub 130 may be connected to network infrastructure 150 using a WAN backhaul transport network 140. For example, the WAN backhaul transport network 140 may be wired or wireless. For example, the network infrastructure 150 may be a radio access network (RAN) for wireless access (e.g., a next generation node B (gNB)). In one example, the network infrastructure 150 is configured to host a plurality of Internet applications.

In one example, the power consumption by a network hub may be relatively high for bursty traffic (e.g., with a low duty cycle). For example, the network hub or network infrastructure may use an inactivity timer of approximately 10 seconds. For example, the inactivity timer maintains a WAN client connection in an active state. In one example, signaling overhead may dominate a power budget when the client connection is in the active state.

In one example, a physical layer solution such as physical layer sleep modes may be used to inactivate network devices using, for example, WWAN idle/connected state switching, WWAN connected discontinuous reception (DRX), WLAN target wait time (TWT), etc. However, physical layer sleep modes do not synchronize sleep modes across different radio technologies and across different operating systems. This motivates a higher layer power management technique, for example, a power management technique at a network layer (e.g., IP layer). A network layer power management technique may facilitate improved dc power efficiency if active/idle traffic periods among a plurality of client nodes are jointly coordinated (i.e., synchronized). For example, during an idle mode, the WAN network backhaul network may be placed into a deep sleep mode.

In one example, a radio technology (i.e., physical layer) may include dc power savings protocols at short or medium time scales within that radio technology. For example, a short time scale (i.e., much less than one second time interval) is used to make these protocols imperceptible to a human end user. For example, a new radio (NR) connected DRX cycle has an awake duration of 10 ms every 160 ms. For example, a WLAN target wakeup time (TWT) enables nodes to request a desired sleep cycle, for example, 20 ms or 320 ms. For example, NR and WLAN specifications support methods for a client node to request a specific paging cycle (e.g., Idle DRX).

An example Internet scenario may include a mobile hotspot (MHS) as a network hub which connects to a 5G (fifth generation wireless) backhaul as a WAN backhaul transport network and to a wireless LAN (WLAN) as a plurality of LAN access paths for client access. For example, a first client node may use an Android device which follows a doze protocol for dc power savings. For example, the doze protocol uses a maintenance window which appears every 10 minutes.

For example, a second client node may use an Apple device which uses a sleep management protocol to execute maintenance every 12 minutes. For example, a third client node may use a Snapdragon device which uses a proprietary protocol to synchronize background traffic and reduce dc power consumption. For example, maintenance may occur every 15 minutes.

In one example, for the Internet scenario, the mobile hotspot connects to the 5G backhaul at least at the following time intervals: 0 min., 10 min., 12 min., 15 min. 20 min, etc. due to the asynchronicity among the three client nodes. That is, for every client maintenance event, a 5G radio connection must be executed with a high overhead ratio since little traffic is actually carried. For example, the 5G radio connection may tend to have a long inactivity timer since the network architecture aims to amortize a high signaling cost for activating and deactivating a radio link which results in a high dc power consumption.

The following Table 1 illustrates an example dc current draw comparison between a standby mode and a connected mode.

TABLE 1

| | | Normalized |
|---|---|---|
| | | power |
| Use case | WAN router Use case description | consumption |
| 1 | WWAN in RRC idle, one WiFi | 1 |
| | client connected | |
| 2 | In RRC connected, one WiFi | 1.57 |
| | client connected | |

For example, use case 1 has client nodes connected to a WWAN router without data traffic and use case 2 has client nodes connected to the WWAN router with data traffic and a WWAN radio remains connected. In this example, dc power consumption increases 57% (e.g., for approximately 10 seconds) whenever there is data traffic on the LAN access network.

In one example, certain background applications, machines, and protocols may operate on a much longer time scale (i.e., greater than one minute time interval). For example, a transmission control protocol (TCP) connection has a keep alive feature every 5 minutes. For example, an operating system (e.g., Android) doze maintenance window is every 10 minutes (e.g., including news fetching). For example, a meter report may occur four times per hour.

In one example, a physical layer solution creates sleep/wake cycles for an Internet device and attempts to concentrates all latency insensitive traffic to a single connection. For example, a cloud messaging service operates from a network cloud to an Internet device to support downstream messaging between backend services and device applications. However, the physical layer solution does not coordinate with other Internet devices on the LAN access network such a different solution is needed for network synchronization.

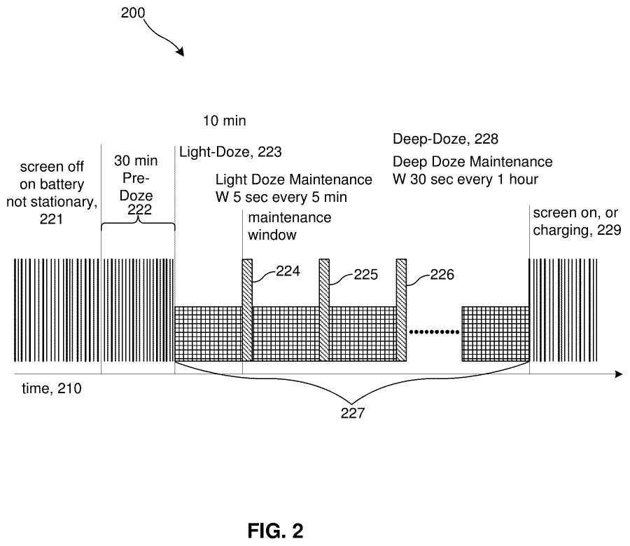

FIG. 2 illustrates an example physical layer doze mode timeline 200. In one example, the timeline 200 is shown as a function of time on a horizontal axis 210. For example, the timeline 200 includes a screen off on battery phase 221, a pre-doze phase 222, a light doze phase 223, a deep doze phase 228 and a screen on or charging phase 229.

In one example, the light doze phase 223 includes a first light doze maintenance event 224, a second light doze maintenance event 225 and a third light doze maintenance event 226 all within a maintenance window 227. For example, each light doze maintenance event may be 5 seconds in duration with a repetition interval of 5 minutes. In one example, the deep doze phase 228 includes a deep doze maintenance event 30 seconds in duration with a repetition interval of one hour.

In one example, during the doze mode, Internet applications may not access the LAN access network, run synchronization adapters, fire standard alarms, run scheduled tasks, acquire wakelocks (e.g., sleep mode modifications), etc. In one example, delaying or grouping uplink packet transmission (i.e., packet transmission from Internet devices to network infrastructure) in a modem may not be feasible since a transport layer protocol (e.g., transmission control protocol (TCP)) may have a tight expiry timer which may cause a connection error to a host. For example, stopping or manipulating traffic may not be performed in the modem and should be performed in an HLOS or host to avoid a connection error and other transport layer problems.

In one example, an Internet architecture may employ a network layer dc power savings synchronization solution instead of a physical layer solution. In one example, the Internet architecture operates in accordance with a layered structure. For example, the layered structure is an architectural framework with a plurality of layers (i.e., functional hierarchy) to delineate various processing steps executed in a communication session between two nodes (e.g., between a client node and a switching node, between a switching node and an infrastructure node, etc.).

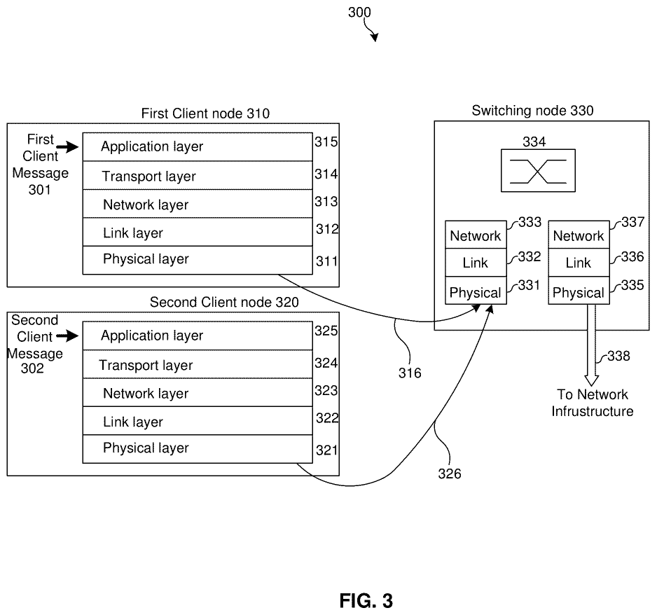

FIG. 3 illustrates an example layered structure 300 for an Internet architectural framework. In one example, the Internet architectural framework 300 includes a first client node 310 and a second client node 320 which communicate with a switching node 330. In one example, the first client node 310 generates a first client message 301 and the second client node 320 generates a second client message 302. In one example, the first client node 310 includes a wireless WAN (WWAN) router to inform clients of a backhaul status to allow low power overhead. In one example, the second client node 320 includes a wireless WAN (WWAN) router to inform clients of a backhaul status to allow low power overhead.

In one example, the first client message 301 is sent to the switching node 330 via a first client access link 316 after encapsulation and the second client message 302 is sent to the switching node 330 via a second client access link 326 after encapsulation. In one example, encapsulation refers to a series of processing steps where a client message is reformatted and transformed into a physical signal which is compatible with a client access link. In one example, the layered structure 300 may also be used for a home network with a plurality of user devices.

For example, the first client message 301 is reformatted and transformed into a first physical signal which is transported by the first client access link 316. For example, the second client message 302 is reformatted and transformed into a second physical signal which is transported by the second client access link 326. In general, the first physical signal (not shown) and the second physical signal (not shown) conform to different physical layer protocols (e.g., WiFi, Ethernet, Bluetooth, USB, etc.) such that the first client access link 316 and the second client access link 326 are incompatible. Moreover, the first client access link 316 and the second client access link 326 operate asynchronously (i.e., with separate time scales).

In one example, encapsulation in the first client node 310 is executed by a first plurality of layers. In one example, the first client message 301 is successively reformatted and transformed by a first application layer 315, a first transport layer 314, a first network layer 313, a first link layer 312 and a first physical layer 311 to produce the first physical signal for the first client access link 316.

In one example, encapsulation in the second client node 320 is executed by a second plurality of layers. In one example, the second client message 302 is successively reformatted and transformed by a second application layer 325, a second transport layer 324, a second network layer 323, a second link layer 322 and a second physical layer 321 to produce the second physical signal for the second client access link 326.

In one example, the first transport layer 314 and the second transport layer 324 conform to a common transport layer (i.e., employ a compatible transport layer protocol). In one example, the first network layer 313 and the second network layer 323 conform to a common network layer (i.e., employ a compatible network layer protocol). For example, the compatible transport layer protocol may be Transmission Control Protocol (TCP) or User Datagram Protocol (UDP). For example, the compatible network layer protocol may be Internet Protocol (IP).

In one example, the first link layer 312 and the second link layer 322 are incompatible (i.e., have distinct link layer protocols). In one example, the first physical layer 311 and the second physical layer 321 are incompatible (i.e., have distinct physical layer protocols). As a result, the first client access link 316 and the second client access link 326 are independent of each other and may use different transmission media, waveforms, modulation schemes, error correction coding, synchronization techniques, etc.

In one example, usage of a common network layer for the first network layer 313 and the second network layer 323 allows a harmonious internetworking solution even when the first link layer 312 and the second link layer 322 are incompatible and when the first physical layer 311 and the second physical layer 321 are incompatible and asynchronous. For example, the common network layer is an IP network layer.

In one example, the first client access link 316 and the second client access link 326 are terminated at the switching node 330. In one example, a third physical layer 331 in the switching node 330 is compatible with both the first physical layer 311 and the second physical layer 321. In one example, a third link layer 332 in the switching node 330 is compatible with both the first link layer 312 and the second link layer 322. In one example the third physical layer 331 may include a plurality of individual physical layers, each compatible with a particular physical layer protocol. In one example the third link layer 332 may include a plurality of individual link layers, each compatible with a particular link layer protocol.

In one example, a third network layer 333 in the switching node 330 uses a common network layer (e.g., an IP network layer). In one example, the third network layer 333 receives a compatible version of the first client message 301 and a compatible version of the second client message 302 which are both sent to a network router 334 (or a network switch). In one example, the network router 334 interprets forwarding information (e.g., an IP address) embedded in the compatible version of the first client message 301 and the compatible version of the second client message 302 to determine a forwarding destination. In one example, a compatible version of a client message conforms to a common network layer protocol (e.g., IP protocol).

In one example, the compatible version of the first client message 301 and the compatible version of the second client message 302 are successively reformatted and transformed by a fourth network layer 337, a fourth link layer 336 and a fourth physical layer 335 to produce a backhaul signal 338 sent to the forwarding destination over a backhaul transport link (not shown).

In one example, the network layer dc power savings synchronization solution for the Internet architecture employs a coordinated scheduling strategy. In one example, a group of client nodes is created, for example, all client devices which are served by a network hub (e.g., WWAN router) may form the group. In one example, one client node in the group of client nodes is designated as a master client node. For example, the master client node proposes a sleep/power pattern with a plurality of pattern elements. For example, the plurality of pattern elements includes a cycle (i.e., an awake time periodicity), an on duration (i.e., an awake time duration), a common time reference (i.e., a shared resource for all client nodes to provide a common notion of time), etc. In one example, the common time reference may be a usage of a network time protocol (NTP) among all client nodes. The switching node may act as an NTP server, allowing clients to obtain time from the same source. In one example, the common time reference may be a usage of synchronized timestamp delivered to all client nodes from a master clock.

In one example, the master client node may modify the pattern elements of the sleep/power pattern based on comments and feedback received from other client nodes. In one example, the other client nodes may respond (e.g., via a multicasting protocol) with comments or suggestions to modify the pattern elements. In one example, the other client nodes may vote to endorse or reject a proposed sleep/power pattern by providing a binary indication of approval or disapproval for the proposed sleep/power pattern. In one example, other client nodes may request a shorter cycle or longer awake time, etc. In one example, the master client node may update and transmit the updated proposed sleep/power pattern to generate a consensus sleep/power pattern with consensus pattern elements.

In one example, each client node of the plurality of client nodes receives the consensus sleep/power pattern to synchronize its tasks according to the consensus pattern elements. For example, each client node uses a common time reference for synchronization of its tasks. In one example, each client node determines which of its tasks are latency-tolerant tasks (i.e., tasks which do not require an immediate or real-time response). In one example, each client node delays a latency-tolerant task according to the cycle and the on duration using the common time reference. In one example, other client nodes may delay traffic until the next occurrence of the awake portion of the cycle.

In one example, the delaying of each latency-tolerant task for each client node facilitates a common synchronization of client node tasks. In one example, a latency-tolerant task may be background traffic such as file backup, system health monitoring reporting, transport layer connection keep alive, etc. In one example, a client HLOS in each client node synchronize its tasks according to the consensus pattern elements. In one example, each client node (e.g., each client HLOS) may mark latency-tolerant connections such that a plurality of response messages in a return direction may be buffered. In one example, the marking of latency-tolerant connection may be inserted in an IP header, for example, in the Type of Service (TOS) field or as a Diff Serv mark.

In one example the WWAN router may provide information to the LAN clients about the state of the backhaul. i.e. backhaul radio connection is active/idle. The WWAN router may broadcast this information, for instance as a field in a Wi-Fi beacon, or as a multicast/broadcast Ethernet frame. When the backhaul connection is indicated to be active, LAN clients may take the opportunity to initiate network traffic, which incurs low additional power overhead. In one example, the WWAN router may indicate a time duration until the backhaul WWAN radio will go idle. The LAN clients may schedule their network traffic in an attempt to complete their transaction before the WWAN radio goes idle.

In one example, an extension to the network layer dc power savings synchronization solution may include a network infrastructure synchronization solution. In one example, the network infrastructure may be a radio access network (RAN) for wireless access (e.g., a next generation node B, gNB, or core network). In one example, the network infrastructure (e.g., gNB or core network) may examine a network layer header field (e.g., IP header field) to determine if a particular traffic or task is latency-tolerant. For example, in the core network, an IP packet gateway function, such as an access and mobility management function (AMF) or a user plane function (UPF), may examine the network layer header field and inform the RAN (e.g., gNB) if the particular traffic or task is latency-tolerant. In one example, the RAN is part of a multicast group created by a mobile hotspot such that the RAN is aware of a relative timing of a next awake cycle. In one example, the RAN delays a paging message to the network hub (e.g., WWAN router) until the next awake cycle commences.

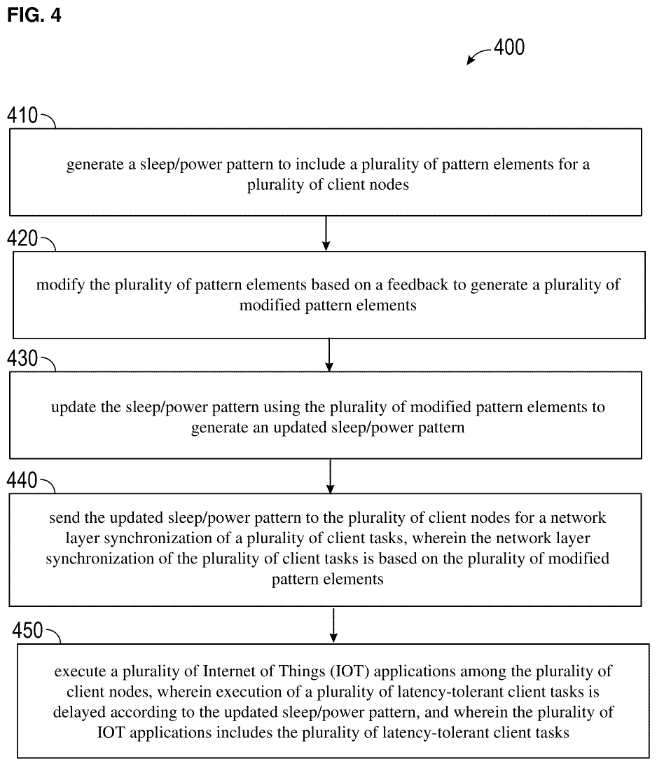

FIG. 4 illustrates an example flow diagram 400 for an Internet architecture network layer dc power savings synchronization solution. A plurality of client nodes is aggregated and a master client node is assigned in an Internet architecture. In one example, the plurality of client nodes includes all client devices which are served by a network hub (e.g., WWAN router). In one example, the plurality of client nodes are connected to the network hub via a plurality of client access links. In one example, aggregate means assign to a shared client community. In one example, one client node in the plurality of client nodes is designated as the master client node. In one example, the master client node has access to a master clock with a precision time reference (e.g., Global Positioning System (GPS), a national time standard network, an atomic frequence reference timekeeping system, or a local clock such as a common CMOS clock, etc.). In one example, the access may be local or remote.

In block 410, generate a sleep/power pattern to include a plurality of pattern elements for a plurality of client nodes. In one example, a sleep/power pattern is generated to include a plurality of pattern elements for a plurality of client nodes. In one example, the proposed sleep/power pattern is sent to the plurality of client nodes via a broadcast. In one example, the sleep/power pattern is a periodic sleep/power pattern with a period equal to a duration of an awake time.

In one example, the plurality of pattern elements includes a cycle (i.e., an awake time periodicity), an ON duration (i.e., an awake time duration), a common time reference (i.e., a shared resource for all client nodes to provide a common notion of time), etc. In one example, the common time reference may be obtained through usage of a network time protocol (NTP) among all client nodes. In one example, the master clock with a precision time reference provides the common time reference.

In one example, the common time reference may be obtained through usage of a precision time protocol (PTP) among all client nodes. In one example, the common time reference may be obtained through usage of synchronized timestamp delivered to all client nodes from a master clock. In one example, the common time reference may be derived from Global Positioning System (GPS) time through a Global Positioning System (GPS) receiver.

In block 420, modify the plurality of pattern elements based on a feedback to generate a plurality of modified pattern elements. In one example, the plurality of pattern elements is modified based on a feedback to generate a plurality of modified pattern elements. In one example, the modification is performed by the master client node. In one example, the feedback is received from other client nodes. In one example, the other client nodes may respond (e.g., via a multicasting protocol) with feedback to modify the pattern elements. In one example, the other client nodes may vote to endorse or reject a sleep/power pattern by providing a binary indication of approval or disapproval for the sleep/power pattern. In one example, the plurality of modified pattern elements is determined by a consensus aggregation process using the feedback received from the other client nodes. In one example, consensus aggregation process may use majority voting of the feedback received from the other client nodes. For example, the consensus aggregation process may tally the binary indication of approval or disapproval from each of the other client nodes. In one example, the plurality of modified pattern elements includes a modified cycle (i.e., a modified awake time periodicity), a modified ON duration (i.e., a modified awake time duration), a common time reference (i.e., a shared resource for all client nodes to provide a common notion of time), etc.

In block 430, update the sleep/power pattern using the plurality of modified pattern elements to generate an updated sleep/power pattern. In one example, the sleep/power pattern is updated using the plurality of modified pattern elements to generate an updated sleep/power pattern. In one example, the updated sleep/power pattern establishes a network layer synchronization among the plurality of client nodes. In one example, a network layer synchronization is used since some traffic may not be delay tolerant, and may not obey the synchronization schedule. In one example, the network layer synchronization among the plurality of client nodes provides a common notion of time (i.e., a common timescale) for incompatible and asynchronous client access links. In one example, client access links (e.g., first client access link 316 and second client access link 326 of FIG. 3) connects client nodes (e.g., first client node 310 of FIG. 3, second client node 320 of FIG. 3) with switching node (e.g., switching node 330 of FIG. 3). In one example, a network layer synchronization among the plurality of client nodes establishes a common time reference for each client node of the plurality of client nodes, such that each client node operates synchronously with the other client nodes of the plurality of client nodes.

In block 440, send the updated sleep/power pattern to the plurality of client nodes for a network layer synchronization of a plurality of client tasks, wherein the network layer synchronization of the plurality of client tasks is based on the plurality of modified pattern elements. In one example, the updated sleep/power pattern is sent to the plurality of client nodes for a network layer synchronization of a plurality of client tasks, wherein the network layer synchronization of the plurality of client tasks is based on the plurality of modified pattern elements. For example, each client node of the plurality of client nodes uses a common time reference obtained from the plurality of modified pattern elements for synchronization of its tasks. In one example, the updated sleep/power pattern includes the plurality of modified pattern elements. In one example, a network layer synchronization of the plurality of client tasks provides a common time reference for each client task such that each client task executes synchronously with the other client tasks of the plurality of client tasks.

In block 450, execute a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks. In one example, a plurality of Internet applications is executed among the plurality of client nodes, wherein execution of a plurality of latency-tolerant client tasks is delayed according to the updated sleep/power pattern, and wherein the plurality of Internet applications includes the plurality of latency-tolerant client tasks.

In one example, the latency-tolerant client tasks are client tasks which do not require an immediate or real-time response. In one example, the execution of the latency-tolerant client tasks are delayed according to the modified cycle (i.e., the modified awake time periodicity) and the modified ON duration using the common time reference. In one example, the delaying of each latency-tolerant client task facilitates a common synchronization of client tasks. In one example, a client HLOS in each client node synchronize its client tasks according to the modified pattern elements.

In one aspect, one or more of the steps for providing network layer power savings synchronization in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a first client node configured to execute a first plurality of Internet applications;
a second client node configured to execute a second plurality of Internet applications; and
a switching node coupled to the first client node and the second client node, the switching node configured to enable execution of the first plurality of Internet applications and the second plurality of Internet applications synchronously using a network layer synchronization.

2. The apparatus of claim 1, further comprising a network infrastructure coupled to the switching node, the network infrastructure configured to host the first plurality of Internet applications and the second plurality of Internet applications.

3. The apparatus of claim 2 further comprising:
a first client access link coupled to the first client node, the first client access link configured to connect the first client node to the switching node; and
a second client access link coupled to the second client node, the second client access link configured to connect the second client node to the switching node.

4. The apparatus of claim 3, further comprising a common time reference coupled to the first client node, the common time reference configured to provide a common notion of time for the first client access link and the second client access link, wherein the first client access link and the second client access link are incompatible and asynchronous.

5. The apparatus of claim 4, wherein the common time reference is obtained through one of the following: a usage of a network time protocol (NTP), a usage of a precision time protocol (PTP) or derived from Global Positioning System (GPS) time through a Global Positioning System (GPS) receiver.

6. The apparatus of claim 1, wherein the first client node is further configured to generate a sleep/power pattern to include a plurality of pattern elements for the second client node.

7. The apparatus of claim 6, wherein the second client node votes to endorse or reject the sleep/power pattern by a binary indication of approval or disapproval.

8. An apparatus comprising:
means for updating a sleep/power pattern using a plurality of modified pattern elements to generate an updated sleep/power pattern;
means for sending the updated sleep/power pattern to a plurality of client nodes for a network layer synchronization of a plurality of client tasks, wherein the network layer synchronization of the plurality of client tasks is based on the plurality of modified pattern elements; and
means for executing a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks.

9. The apparatus of claim 8, further comprising means for modifying a plurality of pattern elements based on a feedback to generate the plurality of modified pattern elements.

10. The apparatus of claim 9, further comprising means for generating the sleep/power pattern to include the plurality of pattern elements for the plurality of client nodes.

11. A method comprising:
updating a sleep/power pattern using a plurality of modified pattern elements to generate an updated sleep/power pattern;
sending the updated sleep/power pattern to a plurality of client nodes for a network layer synchronization of a plurality of client tasks, wherein the network layer synchronization of the plurality of client tasks is based on the plurality of modified pattern elements; and
executing a plurality of Internet applications among the plurality of client nodes, wherein execution of a plurality of latency-tolerant client tasks is delayed according to the updated sleep/power pattern, and wherein the plurality of Internet applications includes the plurality of latency-tolerant client tasks.

12. The method of claim 11, further comprising modifying a plurality of pattern elements based on a feedback to generate the plurality of modified pattern elements.

13. The method of claim 12, further comprising generating the sleep/power pattern to include the plurality of pattern elements for the plurality of client nodes.

14. The method of claim 13, wherein each of the plurality of client nodes votes to endorse or reject the sleep/power pattern by a binary indication of approval or disapproval.

15. The method of claim 13, further comprising establishing a network layer synchronization among the plurality of client nodes using the updated sleep/power pattern.

16. The method of claim 15, wherein the network layer synchronization among the plurality of client nodes provides a common notion of time for incompatible and asynchronous client access links.

17. The method of claim 11, wherein the network layer synchronization of the plurality of client tasks provides a common time reference for each of the plurality of client tasks such that the each of the plurality of client tasks executes synchronously with the others of the plurality of client tasks.

18. The method of claim 17, wherein the plurality of modified pattern elements includes a modified awake time periodicity.

19. The method of claim 18, wherein the execution of the plurality of latency-tolerant client tasks is delayed according to the modified awake time periodicity and a modified ON duration using the common time reference.

20. The method of claim 17, wherein the common time reference is obtained through one of the following: a usage of a network time protocol (NTP), a usage of a precision time protocol (PTP) or derived from Global Positioning System (GPS) time through a Global Positioning System (GPS) receiver.
